(19) United States
(12) Patent Application Publication
(10) Pub. No.: US 2015/0322328 A1
(43) Pub. Date: Nov. 12, 2015

(54) COLLOIDAL HIGH ASPECT RATIO NANOSILICA ADDITIVES IN SEALANTS AND METHODS RELATING THERETO

(71) Applicant: Halliburton Energy Services, Inc., Houston, TX (US)

(72) Inventors: Peter James Boul, Houston, TX (US); B. Raghava Reddy, The Woodlands, TX (US); Xueyu Pang, Houston, TX (US); Walmy Cuello Jimenez, Houston, TX (US)

(73) Assignee: Halliburton Energy Services, Inc., Houston, TX (US)

(21) Appl. No.: 14/405,689

(22) PCT Filed: Jan. 29, 2014
(86) PCT No.: PCT/US2014/013492

§ 371 Date: Dec. 4, 2014

(51) Int. Cl. C09K 8/42; E21B 43/04; E21B 33/14; E21B 33/13

(52) U.S. Cl. CPC C09K 8/426; E21B 33/13; E21B 43/04; E21B 33/14

(57) ABSTRACT

Colloidal high aspect ratio nanosilica additives that comprise colloidal high aspect ratio nanosilica particles having an average diameter of about 100 nm or less and an average aspect ratio of about 1.5 or greater may be useful in forming sealants in a wellbore, a subterranean formation, or both. For example, a method may include introducing a wellbore fluid into a wellbore penetrating a subterranean formation, the wellbore fluid comprising an aqueous base fluid, an activator, and a colloidal high aspect ratio nanosilica additive; placing the wellbore fluid into a portion of the wellbore, a portion of the subterranean formation, or both; and forming a sealant that comprises the colloidal high aspect ratio nanosilica additive therein.

### BACKGROUND

The present application relates to sealants that comprise colloidal high aspect ratio nanosilica additives, and methods relating thereto.

Sealants that set to hardened masses are used in many applications of hydrocarbon exploration and production (e.g., to support casings introduced into the wellbore to provide zonal isolation of formation fluids from entering the wellbore, as plugs or barriers for zonal isolation along the wellbore, and as barriers between the wellbore and water-producing portions of the subterranean formation).

Generally, the setting and hardening time of a sealant increases with decreasing ambient temperatures, as a result of the decreasing chemical reaction rates. This has become problematic as hydrocarbon exploration extends to colder environments (e.g., the North Sea). For example, in some instances, the waiting time for the sealant to set and harden before further operations can be on the order of days. Typically, to allow for a sealant to set and harden, the wellbore is shut-in, and all other operations cease. As some wells can cost millions a day, especially offshore wells, the non-productive time associated with shut-ins to set and harden a sealant can become costly. Therefore, compositions and methods for reducing the setting and hardening time for sealants may be advantageous.

### BRIEF DESCRIPTION OF THE DRAWINGS

The following figures are included to illustrate certain aspects of the embodiments, and should not be viewed as exclusive embodiments. The subject matter disclosed is capable of considerable modifications, alterations, combinations, and equivalents in form and function, as will occur to those skilled in the art and having the benefit of this disclosure.

FIG. 1A provides a conceptual representation of a portion of a sealant that comprises cigar-shaped colloidal high aspect ratio nanosilica particles.

FIG. 1B provides a conceptual representation of a portion of a sealant that comprises string of pearl shaped colloidal high aspect ratio nanosilica particles.

FIG. 2 shows an illustrative schematic of a system that can deliver wellbore fluids of the present disclosure to a downhole location, according to one or more embodiments.

FIG. 3 shows an illustrative schematic of a system that can deliver wellbore fluids of the present disclosure to a downhole location, according to one or more embodiments.

FIG. 4 provides a heat-of-hydration evolution comparison for the chemical reactions of various wellbore fluids that comprise cement, including wellbore fluids according to one or more embodiments.

FIG. 5 provides a heat-of-hydration evolution comparison for the chemical reactions of various wellbore fluids that comprise cement, including wellbore fluids according to one or more embodiments.

FIG. 6 provides a compressive strength comparison for various sealants that comprise cement, including sealants according to one or more embodiments.

### DETAILED DESCRIPTION

The present application relates to sealants that comprise colloidal high aspect ratio nanosilica additives, and methods relating thereto.

In some embodiments, the inclusion of colloidal high aspect ratio nanosilica additives in a wellbore fluid may reduce the setting and hardening time of the sealant formed therefrom. While colloidal silica has previously demonstrated reductions in setting and hardening time, in some embodiments, the shape of the colloidal silica unexpectedly may be used to further reduce the setting and hardening time of the sealant, especially at lower temperatures (e.g., less than about 20° C.).

As used herein, the term “sealant” refers to a composition that upon setting inhibits the flow of a fluid between two locations (e.g., between portions of the wellbore, between two portions of a subterranean formation, between a portion of a wellbore and a portion of a subterranean formation, or between a portion of the wellbore and a portion of the tubular string disposed therein). In some instances, the permeability (a measure of fluid flow connectivity) of a subterranean formation to fluid flow (e.g., to water) may be reduced by about 60% or greater (e.g., about 75% or greater, or about 95% or greater). Such permeability reductions may be useful in lowering the influx of a fluid (e.g., water) into the wellbore or prevent loss of a treatment fluid from wellbore into the subterranean formation.

In some embodiments, a sealant described herein may comprise colloidal high aspect ratio nanosilica additives. As used herein, the term “colloidal high aspect ratio nanosilica additive” refers to a plurality of colloidal high aspect ratio nanosilica particles, which may be present as individual particles, aggregates thereof, or both. As used herein, the term “colloidal high aspect ratio nanosilica particle” refers to a particle that comprises silica, has an average aspect ratio (i.e., length divided by width or diameter) of about 1.5 or greater, and has an average diameter of about 100 nm or less. However, the term “colloidal high aspect ratio nanosilica particle” does not imply a limitation to a uni-diameter particle or that the particle is straight along its length. For example, as described herein colloidal high aspect ratio nanosilica particles may include cigar-shaped or rice grain-shaped nano-sized particles where the diameter at the midpoint of the length is greater than at the end. In another example, colloidal high aspect ratio nanosilica particles may include a string of pearls configuration of substantially spherical particles. As used herein, the term “string of pearls” refers to two or more substantially spherical particles bound or bridged together in series and not necessarily in a straight line. As used herein, the term “average diameter” and “average aspect ratio” refers to a number average of the diameter and aspect ratio, respectively. As used herein for a colloidal high aspect ratio nanosilica particle with a diameter that changes along the length, the diameter used for determining average diameter and average aspect ratio refers to the largest diameter of the colloidal high aspect ratio nanosilica particle.

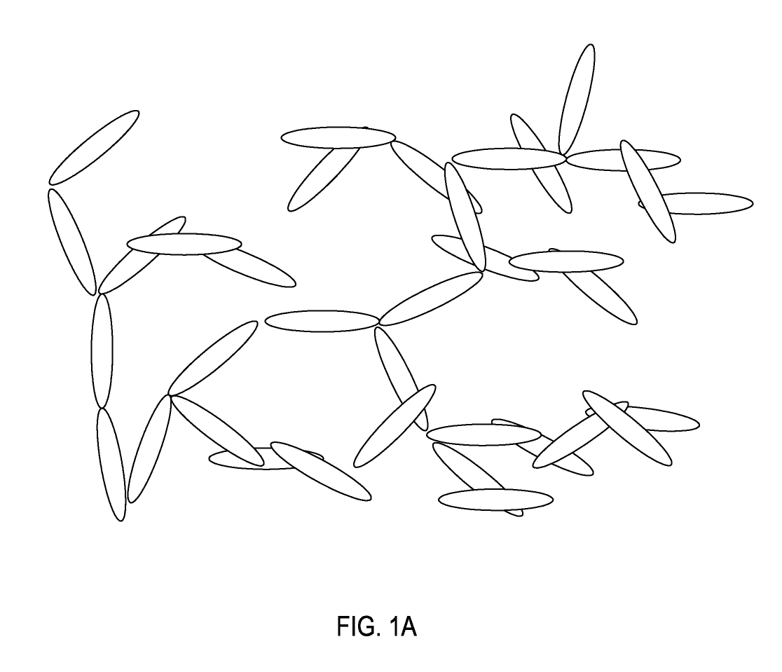

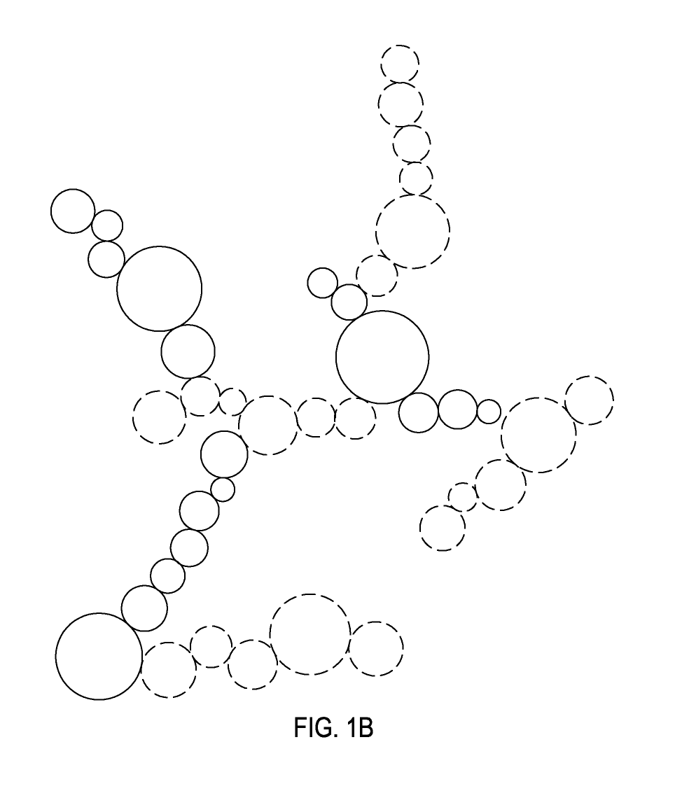

In some embodiments, a sealant described herein or portion thereof may be formed by reacting a colloidal high aspect ratio nanosilica additive and an activator. Without being limited by theory, it is believed that the colloidal high aspect ratio nanosilica particles of the additive have a surface charge. The charge repulsion lessens aggregation and aids in the dispersion of the colloidal high aspect ratio nanosilica particles in the additive. The activator reacts with the surface of the colloidal high aspect ratio nanosilica particles so as to change or reduce the surface charge, which allows for the colloidal high aspect ratio nanosilica particles of the additive to aggregate and form a gel that acts as a sealant. Again without limitation, FIGS. 1A and 1B provide a conceptual representation of a portion of two sealants formed with colloidal high aspect ratio nanosilica additives that comprise cigar-shaped particles and string of pearl particles, respectively. For clarity in FIG. 1B, individual string of pearl particles are drawn as connected circles of either solid or broken lines and where a solid-line circle and broken line circle meet is a contact point of aggregation of individual string of pearl particles.

In some instances, a colloidal high aspect ratio nanosilica additive and an activator may be in the same fluid. For example, some embodiments for forming sealants described herein downhole may include introducing a wellbore fluid into a wellbore penetrating a subterranean formation, the wellbore fluid comprising an aqueous base fluid, an activator, and a colloidal high aspect ratio nanosilica additive described herein; placing the wellbore fluid into a portion of the wellbore, a portion of the subterranean formation, or both; and forming a sealant that comprises the colloidal high aspect ratio nanosilica additive in the portion of the wellbore, the portion of the subterranean formation, or both.

In some instances, a colloidal high aspect ratio nanosilica additive and an activator may be in different fluids. For example, some embodiments for forming sealants described herein downhole may include introducing a first wellbore fluid into a wellbore penetrating a subterranean formation, the first wellbore fluid comprising a first aqueous base fluid and an activator; placing the first wellbore fluid into a portion of the wellbore, a portion of the subterranean formation, or both; contacting the first wellbore fluid with a second wellbore fluid that comprises a second aqueous base fluid and a colloidal high aspect ratio nanosilica additive described herein; and forming a sealant that comprises the colloidal high aspect ratio nanosilica additive in the portion of the wellbore, the portion of the subterranean formation, or both. In some instances, methods described herein may further include repeating the placing the first wellbore fluid and contacting the first wellbore fluid with the second wellbore fluid in series at least twice (e.g., ten times or more).

In some instances, a hybrid of the foregoing methods may be performed.

In some embodiments, a sealant described herein may further comprise a cement. Without being limited by theory, it is believed that in some embodiments, the colloidal high aspect ratio nanosilica additive may act as seeds or nucleation sites from which the cement hydration products to grow, which may accelerate setting and hardening of the sealant, which may improve the mechanical properties of the set sealant composition.

Some embodiments for forming sealants described herein downhole may include introducing a wellbore fluid into a wellbore penetrating a subterranean formation (e.g., behind a casing), the wellbore fluid comprising an aqueous base fluid, a colloidal high aspect ratio nanosilica additive described herein, and a cement (and optionally an activator); placing the wellbore fluid into a portion of the wellbore; and forming a sealant that comprises the colloidal high aspect ratio nanosilica additive and the cement in the portion of the wellbore (e.g., by allowing the cement to set).

In some embodiments, particles of a colloidal high aspect ratio nanosilica additive described herein may comprise particles having an average diameter ranging from a lower limit of about 1 nm, 5 nm, or 10 nm to an upper limit of about 100 nm, 75 nm, or 50 nm, and wherein the average diameter may range from any lower limit to any upper limit and encompasses any subset therebetween.

In some embodiments, the particles of a colloidal high aspect ratio nanosilica additive described herein may comprise particles having an average aspect ratio ranging from a lower limit of about 1.5, 10, 100, or 1000 to an upper limit of about 10,000, 5000, 1000, 100, or 50, and wherein the average aspect ratio may range from any lower limit to any upper limit and encompasses any subset therebetween.

The particles of a colloidal high aspect ratio nanosilica additive described herein may have anisotropic geometrical shape of any symmetry/asymmetry. For example, in some embodiments, the particles of a colloidal high aspect ratio nanosilica additive described herein may comprise particles having a shape selected from: a wire, a rod, a cigar shape, a rice grain shape, a string of pearls, a branch, a dendrite, an ellipsoid, a trapezoidal prism, a prism with any number of edges, an asymmetric prism, a twisted prism, an antiprism, a pyramid with any number of edges, asymmetric pyramid, a dipyramid with any number of edges, a truncated pyramid of any number of edges, an asymmetric star of any number of points, a dipyramidal antiprism with any number of edges, a faceted sphericon, and the like, and any hybrid thereof.

In some embodiments, more than one type of colloidal high aspect ratio nanosilica particles may be included in a colloidal high aspect ratio nanosilica additive. As used here, types of particles may be differentiated by at least one of shape, average diameter, or average aspect ratio, and the like.

In some embodiments, the colloidal high aspect ratio nanosilica additive may be present in a wellbore fluid described herein in an amount ranging from a lower limit of about 0.1%, 1%, 5%, or 10% by weight of the fluid to an upper limit of about 50%, 40%, or 30% by weight of the fluid, and wherein the amount of the colloidal high aspect ratio nanosilica additive may range from any lower limit to any upper limit and encompasses any subset therebetween.

Examples of activators suitable for use in the embodiments described herein may include, but are not limited to, ionic materials such as salts, mineral acids, organic acids, and the like. Examples of salts may include salts of the following: chloride, bromide, nitrate, sulfate, sulfide, acetate, formate, phosphate, a hydroxide of ammonium ions, alkali metals, alkaline earth metals, transition metals, post-transition metals, lanthanide metals, and any combination thereof. For example, activators may include, but are not limited to, sodium chloride, potassium chloride, calcium chloride, sodium nitrate, potassium nitrate, calcium nitrate, and the like, and any combination thereof. More examples of activators suitable for use in the embodiments described herein may include, but are not limited to, an organic ester, an organophosphonate, an aminocarboxylic acid, a hydroxypolycarboxylate, phenol, polyphenol, ascorbic acid, phytic acid, methylglycinediacetic acid, a water-soluble polyepoxysuccinic acid, salicylic acid, tannic acid, and the like, and any combination thereof. In some embodiments, combinations of the foregoing activators may be used.

In some embodiments, the activator may be present in a wellbore fluid described herein in an amount ranging from a lower limit of about 0.001%, 0.01%, or 0.1% by weight of the fluid to an upper limit of about 10%, 5%, or 1% by weight of the fluid, and wherein the amount of the activator may range from any lower limit to any upper limit and encompasses any subset therebetween.

Examples of cements may include, but are not limited to, hydraulic cements, Portland cements, gypsum cements, calcium phosphate cements, high alumina content cements, silica cements, high alkalinity cements, shale cements, acid/base cements, magnesia cements (e.g., Sorel cements), fly ash cements, zeolite cement systems, cement kiln dust cement systems, slag cements, micro-fine cements, and the like, and any combination thereof.

In some embodiments, the cement (when optionally included) may be present in a wellbore fluid described herein in an amount ranging from a lower limit of about 50%, 75%, or 100% by weight of the fluid to an upper limit of about 300%, 200%, or 150% by weight of the fluid, and wherein the amount of the cement may range from any lower limit to any upper limit and encompasses any subset therebetween.

Aqueous base fluids suitable for use in a wellbore fluid described herein may comprise fresh water, saltwater (e.g., water containing one or more salts dissolved therein), seawater, or combinations thereof. Generally, the water may be from any source, provided that it does not contain components that might adversely affect the stability and/or performance of the wellbore fluid described herein.

In some embodiments, other materials that may be included in a wellbore fluid described herein may include, but are not limited to, mineral oils, aqueous miscible fluids, elastomers, viscosifiers, gases such as nitrogen, foaming agents, lightweight materials (e.g., hollow or porous spheres), weighting agents, formates, fluid loss control agents, bridging agents, additives that alter the mechanical properties of the sealant (e.g., fibers to increase the tensile strength), fluid loss control materials, and the like, and any combination thereof.

As mentioned above, the use of colloidal high aspect ratio nanosilica additives described herein may advantageously reduce setting and hardening times of the sealant at lower temperatures. While the methods and compositions described herein may be used at a wide range of bottom hole static temperatures (“BHST”) (e.g., about 20° C. or greater, about 120° C. or greater), in some embodiments, they may be used at a BHST of about 20° C. or less, or 0° C. or less.

In some instances, one should recognize the interrelatedness of the relative concentrations of the each component in the wellbore fluids described herein and the temperature of the subterranean formation as they may affect the setting and hardening time of the sealant. For example, decreasing the concentration ratio of activator relative to the colloidal high aspect ratio nanosilica additive may provide for longer setting and hardening times. In another example, lower temperatures may provide for longer setting and hardening times.

Downhole methods for forming sealants described herein may be similar to conformance operations, diverting operations, plugging operations, primary cementing operations, secondary cementing operations, remedial cementing operations, and the like. For example, the sealants described herein may be used for treating, sealing, or otherwise reducing the fluid flow through at least a portion of a wellbore, through at least a portion of a subterranean formation, through at least a portion of a tubular, or between two of: the wellbore, the subterranean formation, and the tubular. Specific examples of where a sealant described herein may be formed may include, but are not limited to, permeable zones of the subterranean formation, water producing zones of the subterranean formation, an annulus within a wellbore (e.g., an annulus between the wellbore and the casing, an annulus between the casing and a tubular, an annulus between the wellbore and a tubular, and so on), and combinations or hybrids thereof.

In some embodiments, colloidal high aspect ratio nanosilica additives described herein with particles having nano-sized dimensions may be utilized for sealing permeable zones of the formation matrix as the dimensions may advantageously allow for the additive to incorporate and set within the formation matrix. This may be especially advantageous for controlling undesired water or gas production.

In some embodiments, a wellbore fluid may comprise colloidal high aspect ratio nanosilica additives described herein and particulates greater than 0.5 microns (alternately greater than 1 micron, alternately greater than 5 microns (for example cement)). Such wellbore fluids may be preferably suitable for placement in a wellbore (e.g., in an annulus behind a casing) to control flow of formation or treatment fluids between zones connected by the wellbore.

In some embodiments, forming the sealant may involve shutting in the wellbore fluid comprising a colloidal high aspect ratio nanosilica additive to allow the sealant to sufficiently set and harden such that other operations minimally, if at all, effect the integrity of the sealant. One skilled in the art will recognize the appropriate shut-in time (e.g., about 4 to about 76 hours), which may depend on, inter alia, the temperature, the composition of the wellbore fluid (e.g., the relative concentration of the activator and the colloidal high aspect ratio nanosilica additive and the inclusion of cement), the volume of the wellbore fluid, and the like.

In some embodiments, after forming a sealant in a desired location, a method may further include introducing a treatment fluid into the wellbore and diverting the treatment fluid to a second portion of the wellbore, a second portion of the subterranean formation, or both.

In various embodiments, systems configured for delivering the wellbore fluids described herein to a downhole location are described. In various embodiments, the systems can comprise a pump fluidly coupled to a tubular, the tubular containing a wellbore fluid that comprises an aqueous base fluid and a colloidal high aspect ratio nanosilica additive described herein (that comprises colloidal high aspect ratio nanosilica particles having an average diameter of about 100 nm or less and an average aspect ratio of about 1.5 or greater), and the wellbore fluid optionally further comprising an activator, a cement, or both.

The pump may be a high pressure pump in some embodiments. As used herein, the term “high pressure pump” will refer to a pump that is capable of delivering a fluid downhole at a pressure of about 1000 psi or greater. A high pressure pump may be used when it is desired to introduce the wellbore fluid to a subterranean formation at or above a fracture gradient of the subterranean formation, but it may also be used in cases where fracturing is not desired. In some embodiments, the high pressure pump may be capable of fluidly conveying particulate matter, such as proppant particulates, into the subterranean formation. Suitable high pressure pumps will be known to one having ordinary skill in the art and may include, but are not limited to, floating piston pumps and positive displacement pumps.

In other embodiments, the pump may be a low pressure pump. As used herein, the term “low pressure pump” will refer to a pump that operates at a pressure of about 1000 psi or less. In some embodiments, a low pressure pump may be fluidly coupled to a high pressure pump that is fluidly coupled to the tubular. That is, in such embodiments, the low pressure pump may be configured to convey the wellbore fluid to the high pressure pump. In such embodiments, the low pressure pump may “step up” the pressure of the wellbore fluid before it reaches the high pressure pump.

In some embodiments, the systems described herein can further comprise a mixing tank that is upstream of the pump and in which the wellbore fluid is formulated. In various embodiments, the pump (e.g., a low pressure pump, a high pressure pump, or a combination thereof) may convey the wellbore fluid from the mixing tank or other source of the wellbore fluid to the tubular. In other embodiments, however, the wellbore fluid can be formulated offsite and transported to a worksite, in which case the wellbore fluid may be introduced to the tubular via the pump directly from its shipping container (e.g., a truck, a railcar, a barge, or the like) or from a transport pipeline. In either case, the wellbore fluid may be drawn into the pump, elevated to an appropriate pressure, and then introduced into the tubular for delivery downhole.

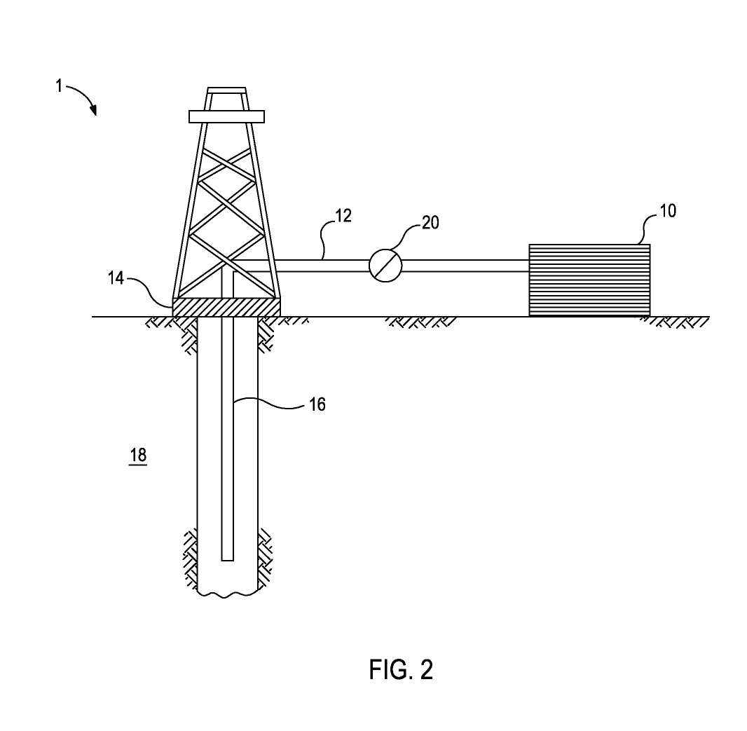

FIG. 2 shows an illustrative schematic of a system that can deliver wellbore fluids described herein to a downhole location, according to one or more embodiments. It should be noted that while FIG. 2 generally depicts a land-based system, it is to be recognized that like systems may be operated in subsea locations as well. As depicted in FIG. 2, system 1 may include mixing tank 10, in which a wellbore fluid of the present invention may be formulated. The wellbore fluid may be conveyed via line 12 to wellhead 14, where the wellbore fluid enters tubular 16, tubular 16 extending from wellhead 14 into subterranean formation 18. Upon being ejected from tubular 16, the wellbore fluid may subsequently penetrate into subterranean formation 18. In some instances, tubular 16 may have a plurality of orifices (not shown) through which the wellbore fluid of the present disclosure may enter the wellbore proximal to a portion of the subterranean formation 18 to be treated. In some instances, the wellbore may further comprise equipment or tools (not shown) for zonal isolation of a portion of the subterranean formation 18 to be treated.

Pump 20 may be configured to raise the pressure of the wellbore fluid to a desired degree before its introduction into tubular 16. It is to be recognized that system 1 is merely exemplary in nature and various additional components may be present that have not necessarily been depicted in FIG. 2 in the interest of clarity. Non-limiting additional components that may be present include, but are not limited to, supply hoppers, valves, condensers, adapters, joints, gauges, sensors, compressors, pressure controllers, pressure sensors, flow rate controllers, flow rate sensors, temperature sensors, and the like.

Although not depicted in FIG. 2, the wellbore fluid may, in some embodiments, flow back to wellhead 14 and exit subterranean formation 18. In some embodiments, the wellbore fluid that has flowed back to wellhead 14 may subsequently be recovered and recirculated to subterranean formation 18.

In alternate embodiments, the systems may comprise a pump fluidly coupled to a tubular (e.g., a casing, drill pipe, production tubing, coiled tubing, etc.) extending into a wellbore penetrating a subterranean formation, the tubular may be configured to circulate or otherwise convey a wellbore fluid that comprises an aqueous base fluid and a colloidal high aspect ratio nanosilica additive described herein (that comprises colloidal high aspect ratio nanosilica particles having an average diameter of about 100 nm or less and an average aspect ratio of about 1.5 or greater), and the wellbore fluid optionally further comprising an activator, a cement, or both

In some embodiments, the systems described herein may further comprise a mixing tank arranged upstream of the pump and in which the wellbore fluid is formulated. In various embodiments, the pump (e.g., a low pressure pump, a high pressure pump, or a combination thereof) may convey the wellbore fluid from the mixing tank or other source of the wellbore fluid to the tubular. In other embodiments, however, the wellbore fluid can be formulated offsite and transported to a worksite, in which case the wellbore fluid may be introduced to the tubular via the pump directly from a transport vehicle or a shipping container (e.g., a truck, a railcar, a barge, or the like) or from a transport pipeline. In yet other embodiments, the wellbore fluid may be formulated on the fly at the well site where components of the wellbore fluid are pumped from a transport (e.g., a vehicle or pipeline) and mixed during introduction into the tubular. In any case, the wellbore fluid may be drawn into the pump, elevated to an appropriate pressure, and then introduced into the tubular for delivery downhole.

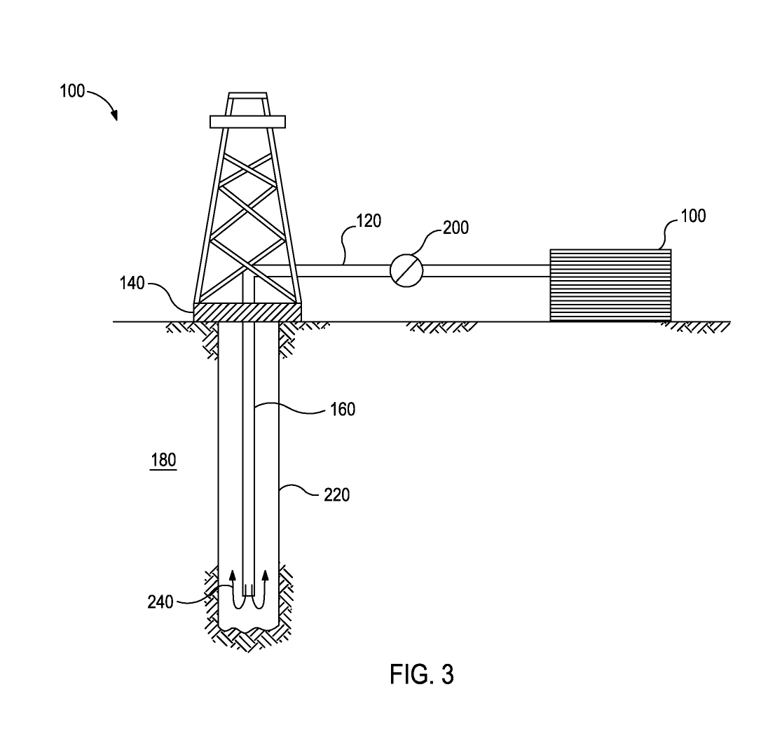

FIG. 3 shows an illustrative schematic of a system that can deliver wellbore fluid of the present invention to a downhole location, according to one or more embodiments. It should be noted that while FIG. 3 shows generally depicts a land-based system, it is to be recognized that like systems may be operated in subsea locations as well. As depicted in FIG. 3 shows, system 101 may include mixing tank 110, in which a wellbore fluid of the present invention may be formulated. Again, in some embodiments, the mixing tank 110 may represent or otherwise be replaced with a transport vehicle or shipping container configured to deliver or otherwise convey the wellbore fluid to the well site. The wellbore fluid may be conveyed via line 112 to wellhead 114, where the wellbore fluid enters tubular 116 (e.g., a casing, drill pipe, production tubing, coiled tubing, etc.), tubular 116 extending from wellhead 114 into wellbore 122 penetrating subterranean formation 118. Upon being ejected from tubular 116, the wellbore fluid may subsequently return up the wellbore in the annulus between the tubular 116 and the wellbore 122 as indicated by flow lines 124. In other embodiments, the wellbore fluid may be reverse pumped down through the annulus and up tubular 116 back to the surface, without departing from the scope of the disclosure. Pump 120 may be configured to raise the pressure of the wellbore fluid to a desired degree before its introduction into tubular 116 (or annulus). It is to be recognized that system 101 is merely exemplary in nature and various additional components may be present that have not necessarily been depicted in FIG. 3 in the interest of clarity. Non-limiting additional components that may be present include, but are not limited to, supply hoppers, valves, condensers, adapters, joints, gauges, sensors, compressors, pressure controllers, pressure sensors, flow rate controllers, flow rate sensors, temperature sensors, and the like.

One skilled in the art, with the benefit of this disclosure, should recognize the changes to the system described in FIG. 3 to provide for other operations (e.g., squeeze operations, reverse cementing (where the wellbore fluid is introduced into an annulus between a tubular and the wellbore and returns to the wellhead through the tubular), and the like).

It is also to be recognized that the disclosed wellbore fluids may also directly or indirectly affect the various downhole equipment and tools that may come into contact with the wellbore fluids (or treatment fluids) during operation. Such equipment and tools may include, but are not limited to, wellbore casing, wellbore liner, completion string, insert strings, drill string, coiled tubing, slickline, wireline, drill pipe, drill collars, mud motors, downhole motors and/or pumps, surface-mounted motors and/or pumps, centralizers, turbolizers, scratchers, floats (e.g., shoes, collars, valves, etc.), wellbore projectiles (e.g., wipers, plugs, darts, balls, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like. Any of these components may be included in the systems generally described above and depicted in FIG. 3.

Embodiments disclosed herein include:

A. a method that includes introducing a wellbore fluid into a wellbore penetrating a subterranean formation, the wellbore fluid comprising an aqueous base fluid, an activator, and a colloidal high aspect ratio nanosilica additive, wherein the colloidal high aspect ratio nanosilica additive comprises colloidal high aspect ratio nanosilica particles having an average diameter of about 100 nm or less and an average aspect ratio of about 1.5 or greater; placing the wellbore fluid into a portion of the wellbore, a portion of the subterranean formation, or both; and forming a sealant that comprises the colloidal high aspect ratio nanosilica additive in the portion of the wellbore, the portion of the subterranean formation, or both;

B. a method that includes introducing a wellbore fluid into a wellbore penetrating a subterranean formation, the wellbore fluid comprising an aqueous base fluid, a cement, and a colloidal high aspect ratio nanosilica additive, wherein the colloidal high aspect ratio nanosilica additive comprises colloidal high aspect ratio nanosilica particles having an average diameter of about 100 nm or less and an average aspect ratio of about 1.5 or greater, and wherein the wellbore fluid optionally further comprises an activator; placing the wellbore fluid into a portion of the wellbore; and forming a sealant that comprises the colloidal high aspect ratio nanosilica additive and the cement in the portion of the wellbore;

C. a method that includes introducing a first wellbore fluid into a wellbore penetrating a subterranean formation, the first wellbore fluid comprising a first aqueous base fluid and an activator; placing the first wellbore fluid into a portion of the wellbore, a portion of the subterranean formation, or both; contacting the first wellbore fluid with a second wellbore fluid that comprises a second aqueous base fluid and a colloidal high aspect ratio nanosilica additive, wherein the colloidal high aspect ratio nanosilica additive comprises colloidal high aspect ratio nanosilica particles having an average diameter of about 100 nm or less and an average aspect ratio of about 1.5 or greater; and forming a sealant that comprises the colloidal high aspect ratio nanosilica additive in the portion of the wellbore, the portion of the subterranean formation, or both, and wherein the method optionally further includes repeating the steps of placing the first wellbore fluid and contacting the first wellbore fluid with the second wellbore fluid in series at least twice;

D. a system that includes a wellhead with a tubular extending therefrom and into a wellbore in a subterranean formation; and a pump fluidly coupled to a tubular, the tubular containing a wellbore fluid comprising an aqueous base fluid, a colloidal high aspect ratio nanosilica additive, and an activator, wherein the colloidal high aspect ratio nanosilica additive comprises colloidal high aspect ratio nanosilica particles having an average diameter of about 100 nm or less and an average aspect ratio of about 1.5 or greater;

E. a system that includes a wellhead with a tubular extending therefrom and into a wellbore in a subterranean formation; and a pump fluidly coupled to a tubular, the tubular containing a wellbore fluid comprising an aqueous base fluid, a colloidal high aspect ratio nanosilica additive, and a cement, wherein the colloidal high aspect ratio nanosilica additive comprises colloidal high aspect ratio nanosilica particles having an average diameter of about 100 nm or less and an average aspect ratio of about 1.5 or greater, and wherein the wellbore fluid optionally further comprises an activator;

F. a wellbore fluid that includes an aqueous base fluid, a colloidal high aspect ratio nanosilica additive, and an activator, wherein the colloidal high aspect ratio nanosilica additive comprises colloidal high aspect ratio nanosilica particles having an average diameter of about 100 nm or less and an average aspect ratio of about 1.5 or greater; and

G. a wellbore fluid that includes an aqueous base fluid, a colloidal high aspect ratio nanosilica additive, and a cement, wherein the colloidal high aspect ratio nanosilica additive comprises colloidal high aspect ratio nanosilica particles having an average diameter of about 100 nm or less and an average aspect ratio of about 1.5 or greater, and wherein the wellbore fluid optionally further includes an activator

Each of embodiments A, B, C, D, E, F, and G may have one or more of the following additional elements in any combination: Element 1: wherein colloidal high aspect ratio nanosilica particles comprise aggregates of individual particles; Element 2: wherein colloidal high aspect ratio nanosilica particles comprise individual particles; Element 3: wherein at least one of the colloidal high aspect ratio nanosilica particles have a string of pearls shape; Element 4: wherein at least one of the colloidal high aspect ratio nanosilica particles have a cigar shape; Element 5: wherein the colloidal high aspect ratio nanosilica particles have an average aspect ratio of about 1.5 to about 10,000; Element 6: wherein the colloidal high aspect ratio nanosilica additive is at about 0.1% to about 50% by weight of the wellbore fluid (or second wellbore fluid); Element 7: wherein the activator comprises a salt comprises one selected from the group consisting of chloride, bromide, nitrate, sulfate, sulfide, acetate, formate, phosphate, a hydroxide of an ammonium ion, an alkali metal, an alkaline earth metal, a transition metal, a post-transition metal, and any combination thereof; Element 8: wherein the activator comprises one selected from the group consisting of sodium chloride, potassium chloride, calcium chloride, sodium nitrate, potassium nitrate, calcium nitrate, and any combination thereof; Element 9: wherein the activator comprises one selected from the group consisting of an organic ester, an organophosphonate, an aminocarboxylic acid, a hydroxypolycarboxylate, phenol, polyphenol, ascorbic acid, phytic acid, methylglycinediacetic acid, a water-soluble polyepoxysuccinic acid, salicylic acid, tannic acid, and any combination thereof; Element 10: wherein the activator is at about 0.001% to about 10% by weight of the wellbore fluid (or first wellbore fluid); and Element 11: wherein the cement (when included) is at about 50% to about 300% by weight of the wellbore fluid.

By way of non-limiting example, exemplary combinations include: Element 1 in combination with Element 2; Element 3 in combination with Element 4; at least one of Elements 1 or 2 in combination with at least one of Elements 3 or 4 and optionally in combination with at least one of Elements 6, 7, 8, 9, 10, or 11; Element 6 in combination with 10 and optionally Element 11; Element 6 in combination with at least one of Elements 7, 8, or 9; at least two of Elements 7, 8, or 9 in combination; and Element 5 in combination with any of the foregoing.

Each of embodiments A, B, and C may have one or more of the following additional elements in any combination (and optionally in combination with any of Elements 1-11): Element 12: wherein a bottom hole static temperature of the wellbore is about 20° C. or less; Element 13: wherein a bottom hole static temperature of the wellbore is about 0° C. or less; Element 14: wherein forming the sealant involves shutting in the wellbore fluid(s); Element 15: wherein the wellbore fluid(s) is placed in the portion of the subterranean formation, and wherein the portion of the subterranean formation comprises a neighboring water-producing zone; Element 16: introducing a treatment fluid into the wellbore; and diverting the treatment fluid to a second portion of the wellbore, a second portion of the subterranean formation, or both; Element 17: wherein the wellbore fluid(s) is placed in a gravel pack at least partially disposed within the wellbore; and Element 18: wherein the wellbore fluid(s) is placed in an annulus between a tubular and the wellbore. By way of non-limiting example, exemplary combinations include: Element 12 or 13 in combination with one of Elements 14, 15, 16, 17, or 18; and the foregoing in combination with one or more of Elements 1-11 (e.g., in combination with the foregoing combinations of Elements 1-11).

One or more illustrative embodiments incorporating the invention embodiments disclosed herein are presented herein. Not all features of a physical implementation are described or shown in this application for the sake of clarity. It is understood that in the development of a physical embodiment incorporating the embodiments of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill the art and having benefit of this disclosure.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques. It should be noted that when “about” is at the beginning of a numerical list, “about” modifies each number of the numerical list. Further, in some numerical listings of ranges, some lower limits listed may be greater than some upper limits listed. One skilled in the art will recognize that the selected subset will require the selection of an upper limit in excess of the selected lower limit.

To facilitate a better understanding of the embodiments of the present invention, the following examples of preferred or representative embodiments are given. In no way should the following examples be read to limit, or to define, the scope of the invention.

### Examples

### Example 1

Seven test tubes were prepared with 25 g of sample according to Table 1 and placed in an 80° F. (27° C.) water bath. Then 5 mL of 5% w/v NaCl in water were added to each test tube. The samples were visually inspected for gelation time, Table 1. Samples exhibiting no flowability when inverted and requiring a spatula to mechanically break where designated as gels.

TABLE 1

| | | | | Approx. Gelation | |
|---|---|---|---|---|---|
| Product Name | Shape | Approx. Size | | Time | |
| * SNOTEX ® ST-XS | spherical | 4-6 | nm | 3 | days |
| * SNOTEX ® ST-UP | cigar | 9-15 nm by | | 1-2 | seconds |
| | | 40-100 nm | | | |
| * SNOTEX ® ST-PS-S | string of | 10-15 nm by | | 3 | hours |
| | pearls | 80-120 nm | | | |
| * SNOTEX ® ST-PS-M | string of | 25-80 nm by | | 3 | days |
| | pearls | 80-150 nm | | | |
| * SNOTEX ® ST-30 | spherical | 10-20 | nm | 3 | days |

| | | | | |
|---|---|---|---|---|
| * SNOTEX ® ST-XL | spherical | 40-60 | nm | none after |
| | | | | 2 days [symbol] [symbol] |
| ** GASCON 469 ™ | spherical | 2-5 | nm*** | none after |
| | | | | 2 days [symbol] |

* colloidal silica, available from Nissan Chemical America Corporation
** liquid cement additive, available from Halliburton Energy Services, Inc.
***measured with a ZETASIZER ™ (light scattering equipment, available from Malvern Instruments) [symbol]
After 2 days at 80° F. (27° C.), the bath temperature was increased to 120° F. (49° C.) and the sample gelled within 6 hours. [symbol] [symbol]
After 2 days at 80° F. (27° C.), the bath temperature was increased to 120° F. (49° C.) and the sample did not gel after 6 hours.

The sample to gel the most rapidly was the cigar-shaped colloidal nanosilica followed by one of the string of pearls-shaped colloidal nanosilica samples. This observation was quite surprising since conventional wisdom would suggest that fluids that include the smallest colloidal nanosilica particles should set the fastest (i.e., the spherical SNOTEX® ST-XS and GASCON 469™). This example demonstrates that the shape of the colloidal nanosilica particles can be used to decrease setting time of the sealants described herein.

### Example 2

Example 1 was repeated at 60° F. (16° C.) for only some of the samples, as shown in Table 2. This example demonstrates the utility of a colloidal high aspect ratio nanosilica additive described herein at low temperatures for decreasing the setting time of the sealants described herein.

TABLE 2

| | | | Approx. Gelation | |
|---|---|---|---|---|
| Product Name | Shape | Size | Time | |
| SNOTEX ® ST-UP | cigar | 9-15 nm by | 1 | minute |
| | | 40-100 nm | | |
| SNOTEX ® ST-PS-S | string of | 10-15 nm by | 6 | hours |
| | pearls | 80-120 nm | | |
| SNOTEX ® ST-PS-M | string of | 25-80 nm by | 12 | hours |
| | pearls | 80-150 nm | | |

### Example 3

Five samples (SNOTEX ST-UP, SNOTEX ST-PS-S, SNOTEX® ST-PS-M, SNOTEX® ST-30, and control with no nanosilica) were prepared to test the effect of the colloidal high aspect ratio nanosilica additives on the reaction rate of a sealant including a cement. The colloidal nanosilica particles were first suspended in water at about 4.5 g particles in 171 g water. The colloidal nanosilica particle dispersion was then added to 450 g of Class H Portland cement and mixed with a Warring blender. The final samples were about 300 mL volume, about 16.6 pounds per gallon (“ppg”) density, and about 0.38 ratio of water-to-cement, and contained about 1% colloidal nanosilica particles by weight of cement (“bwoc”). A 5.5 g of each sample was analyzed with a TAM® air calorimeter (available from TA Instruments) at a 59° F. (15° C.) curing temperature to determine the reaction kinetics, which correlates to the heat flow measurement.

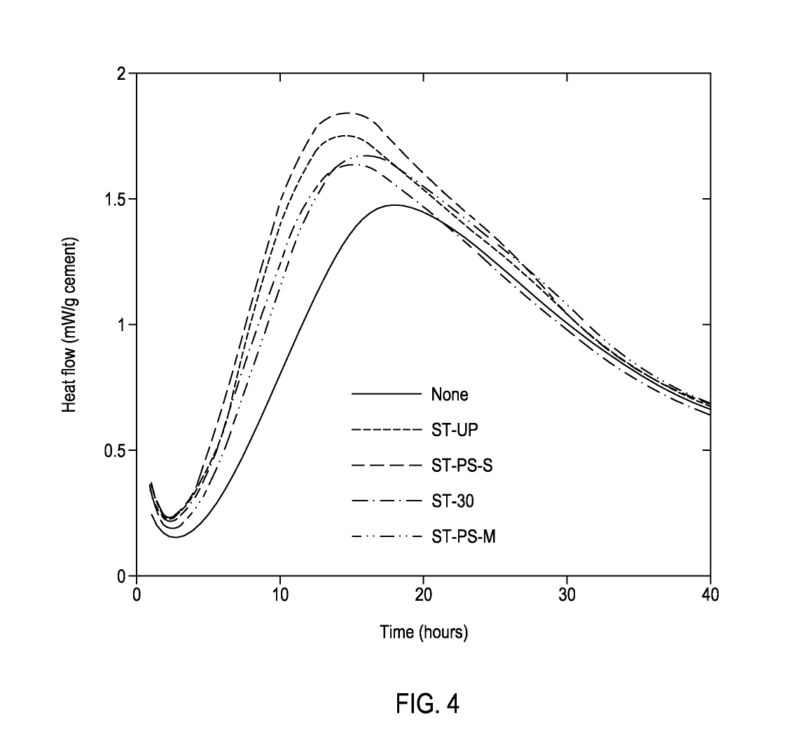

FIG. 4 provides the isothermal calorimetry test results for these samples where the early reaction rate as measured by heat flow was SNOTEX® ST-PS-S˜SNOTEX® ST-UP>SNOTEX® ST-30>SNOTEX® ST-PS-M>control. This indicates that the SNOTEX® ST-PS-S and SNOTEX® ST-UP accelerate the chemical reaction of the sealant including a cement the best. This example illustrates the utility of colloidal high aspect ratio nanosilica additives at low temperatures for decreasing the setting and hardening time of the sealants described herein that comprise a cement.

### Example 4

Six samples (SNOTEX® ST-UP, SNOTEX® ST-PS-S, SNOTEX® ST-XS, SNOTEX® ST-30, SNOTEX® ST-XL, and control with no nanosilica) were prepared as described in Example 3 to include 2% colloidal nanosilica bwoc and have about 13 ppg density and about 0.91 ratio of water-to-cement. In this example, the control sample also included 0.2% bwoc diutan as a suspending aid to mitigate settling and bleeding.

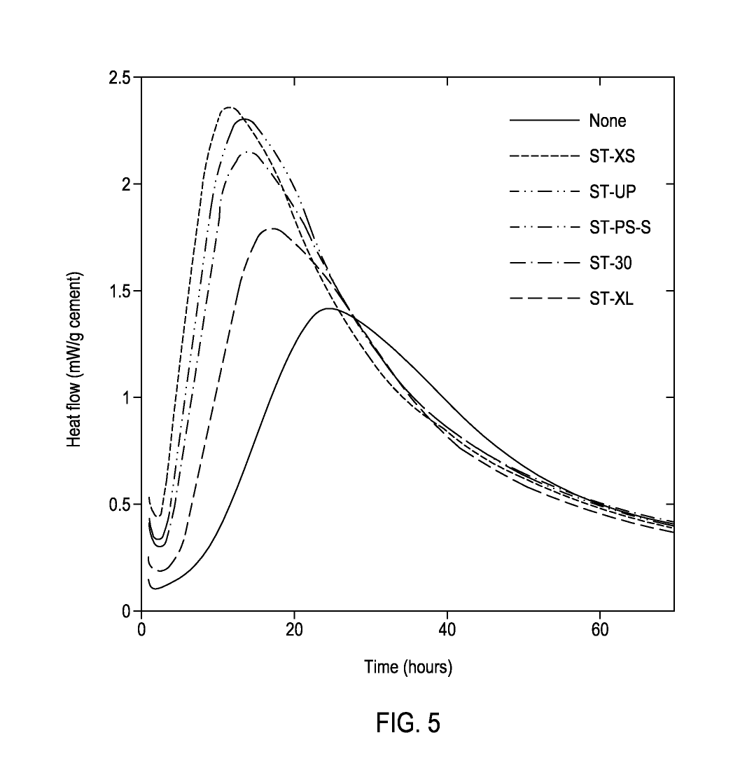

FIG. 5 provides the isothermal calorimetry test results for these samples where early reaction rate as measured by heat flow was SNOTEX® ST-XS>SNOTEX® ST-PS-S˜SNOTEX® ST-UP>SNOTEX® ST-30>SNOTEX® ST-XL>>control. This example illustrates the utility of colloidal high aspect ratio nanosilica additives for decreasing the setting and hardening time of the lightweight sealants described herein that comprise a cement at low temperatures.

### Example 5

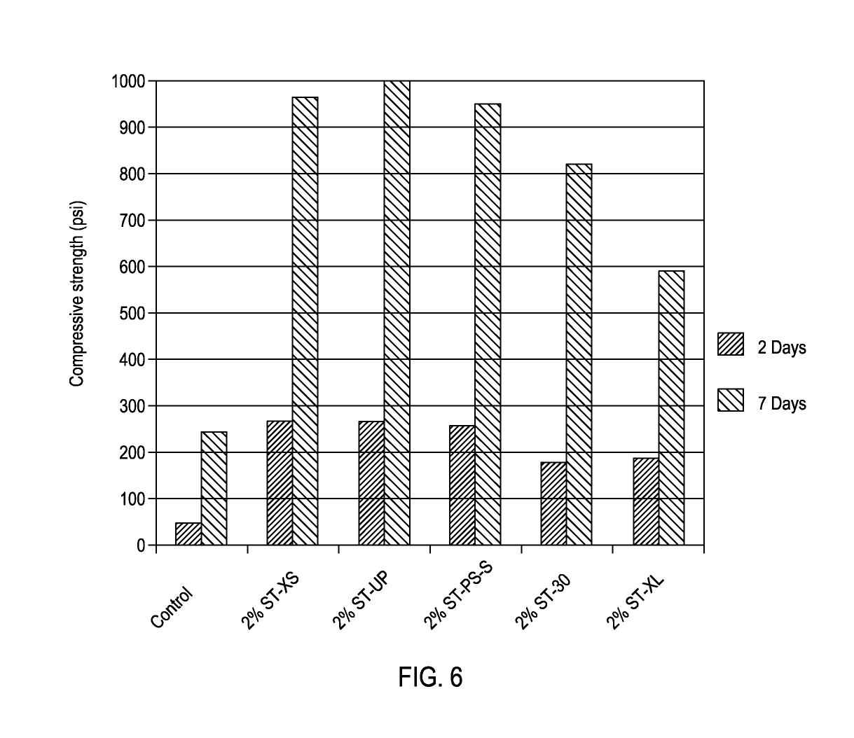

The six samples from Example 4 were cast in 1 inch by 2 inch cylinders and cured at 59° F. (15° C.). The resultant sealants were analyzed via uniaxial compressive strength tests at 2 days and 7 days, FIG. 6. The results are generally consistent with the calorimetry tests. However, the SNOTEX® ST-UP showed the highest compressive strength at 7 days. This example illustrates the utility of colloidal high aspect ratio nanosilica additives at low temperatures for decreasing the hardening time and enhancing the mechanical properties of the sealants described herein that comprise a cement.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

The invention claimed is:

1. A method comprising:
introducing a wellbore fluid into a wellbore penetrating a subterranean formation, the wellbore fluid comprising an aqueous base fluid, an activator, and a colloidal high aspect ratio nanosilica additive, wherein the colloidal high aspect ratio nanosilica additive comprises colloidal high aspect ratio nanosilica particles having an average diameter of about 100 nm or less and an average aspect ratio of about 1.5 or greater;
placing the wellbore fluid into a portion of the wellbore, a portion of the subterranean formation, or both; and
forming a sealant that comprises the colloidal high aspect ratio nanosilica additive in the portion of the wellbore, the portion of the subterranean formation, or both.

2. The method of claim 1, wherein forming the sealant involves shutting in the wellbore fluid.

3. The method of claim 1, wherein colloidal high aspect ratio nanosilica particles comprise aggregates of individual particles.

4. The method of claim 1, wherein at least one of the colloidal high aspect ratio nanosilica particles have a string of pearls shape.

5. The method of claim 1, wherein at least one of the colloidal high aspect ratio nanosilica particles have a cigar shape.

6. The method of claim 1, wherein the colloidal high aspect ratio nanosilica particles have an average aspect ratio of about 1.5 to about 10,000.

7. The method of claim 1, wherein the colloidal high aspect ratio nanosilica additive is at about 0.1% to about 50% by weight of the wellbore fluid.

8. The method of claim 1, wherein the activator comprises a salt that comprises one selected from the group consisting of chloride, bromide, nitrate, sulfate, sulfide, acetate, formate, phosphate, a hydroxide of an ammonium ion, an alkali metal, an alkaline earth metal, a transition metal, a post-transition metal, and any combination thereof.

9. The method of claim 1, wherein the activator comprises one selected from the group consisting of sodium chloride, potassium chloride, calcium chloride, sodium nitrate, potassium nitrate, calcium nitrate, and any combination thereof.

10. The method of claim 1, wherein the activator comprises one selected from the group consisting of an organic ester, an organophosphonate, an aminocarboxylic acid, a hydroxypolycarboxylate, phenol, polyphenol, ascorbic acid, phytic acid, methylglycinediacetic acid, a water-soluble polyepoxysuccinic acid, salicylic acid, tannic acid, and any combination thereof.

11. The method of claim 1, wherein the activator is at about 0.001% to about 10% by weight of the wellbore fluid.

12. The method of claim 1, wherein a bottom hole static temperature of the wellbore is about 20° C. or less.

13. The method of claim 1, wherein the wellbore fluid is placed in the portion of the subterranean formation, and wherein the portion of the subterranean formation comprises a neighboring water-producing zone.

14. The method of claim 1 further comprising:
introducing a treatment fluid into the wellbore; and
diverting the treatment fluid to a second portion of the wellbore, a second portion of the subterranean formation, or both.

15. The method of claim 1, wherein the wellbore fluid is placed in a gravel pack at least partially disposed within the wellbore.

16. The method of claim 1, wherein the wellbore fluid further comprises a cement.

17. The method of claim 16, wherein the wellbore fluid is placed in an annulus between a tubular and the wellbore.

18. A method comprising:
introducing a wellbore fluid into a wellbore penetrating a subterranean formation, the wellbore fluid comprising an aqueous base fluid, a cement, and a colloidal high aspect ratio nanosilica additive, wherein the colloidal high aspect ratio nanosilica additive comprises colloidal high aspect ratio nanosilica particles having an average diameter of about 100 nm or less and an average aspect ratio of about 1.5 or greater;
placing the wellbore fluid into a portion of the wellbore; and
forming a sealant that comprises the colloidal high aspect ratio nanosilica additive and the cement in the portion of the wellbore.

19. A method comprising:
introducing a first wellbore fluid into a wellbore penetrating a subterranean formation, the first wellbore fluid comprising a first aqueous base fluid and an activator;
placing the first wellbore fluid into a portion of the wellbore, a portion of the subterranean formation, or both;
contacting the first wellbore fluid with a second wellbore fluid that comprises a second aqueous base fluid and a colloidal high aspect ratio nanosilica additive, wherein the colloidal high aspect ratio nanosilica additive comprises colloidal high aspect ratio nanosilica particles having an average diameter of about 100 nm or less and an average aspect ratio of about 1.5 or greater; and
forming a sealant that comprises the colloidal high aspect ratio nanosilica additive in the portion of the wellbore, the portion of the subterranean formation, or both.

20. The method of claim 19 further comprising:
repeating placing the first wellbore fluid and contacting the first wellbore fluid with the second wellbore fluid in series at least twice.

21. A system comprising:
a wellhead with a tubular extending therefrom and into a wellbore in a subterranean formation; and
a pump fluidly coupled to a tubular, the tubular containing a sealant fluid comprising an aqueous base fluid, a colloidal high aspect ratio nanosilica additive, and an activator, wherein the colloidal high aspect ratio nanosilica additive comprises colloidal high aspect ratio nanosilica particles having an average diameter of about 100 nm or less and an average aspect ratio of about 1.5 or greater.
